SEQUENCE LISTING (46 sequences)

SEQ ID NO: 1 - protein, 21 aa, Artificial Sequence
  Synthetic peptide
GIVEQCCTSICSLYQLENYCN

SEQ ID NO: 2 - protein, 21 aa, Artificial Sequence
  Synthetic peptide
GIVEQCCTSICSLYQLENCYN

SEQ ID NO: 3 - protein, 21 aa, Artificial Sequence
  Synthetic peptide
GIVEQCCTSICSLYQLENYNC

SEQ ID NO: 4 - protein, 21 aa, Artificial Sequence
  Synthetic peptide
GIVEQCCTSICSLYQLENNYC

SEQ ID NO: 5 - protein, 7 aa, Artificial Sequence
  Synthetic peptide
GFFYTPK

SEQ ID NO: 6 - protein, 7 aa, Artificial Sequence
  Synthetic peptide
GFFYPTK

SEQ ID NO: 7 - protein, 7 aa, Artificial Sequence
  Synthetic peptide
GFFTPYK

SEQ ID NO: 8 - protein, 33 aa, Artificial Sequence
  Synthetic peptide
EAEDLQVGQVELGGGPGAGSLQPLALEGSLQKR

SEQ ID NO: 9 - protein, 33 aa, Artificial Sequence
  Synthetic peptide
EAEDLQVGQVELGGGPGAGSLQPLALEGSLQRK

SEQ ID NO: 10 - protein, 7 aa, Artificial Sequence
  Synthetic peptide
GFFYTPK

SEQ ID NO: 11 - protein, 7 aa, Artificial Sequence
  Synthetic peptide
GFFYPTK

SEQ ID NO: 12 - protein, 4 aa, Artificial Sequence
  Synthetic peptide
NCNY

SEQ ID NO: 13 - protein, 21 aa, Artificial Sequence
  Synthetic peptide
GIVEQCCTSICSLYQLENCNY

SEQ ID NO: 14 - protein, 46 aa, Artificial Sequence
  Synthetic peptide
MALWMRLLPLLALLALWGPDPAAAFVNQHLCGSHLVEALYLVCGER

SEQ ID NO: 15 - protein, 46 aa, Artificial Sequence
  Synthetic peptide
MALWMRLLPLLALLALWGPDPAAAFVNQHLCGEHLVEALYLVCGSR

SEQ ID NO: 16 - protein, 53 aa, Artificial Sequence
  Synthetic peptide
MALWMRLLPLLALLALWGPDPAAAFVNQHLCGSHLVEALYLVCGERGFFYTPK

SEQ ID NO: 17 - protein, 53 aa, Artificial Sequence
  Synthetic peptide
AMLWMRLLPLLALLALWGPDPAAAFVNQHLCGSHLVEALYLVCGERGFYFTPK

SEQ ID NO: 18 - protein, 35 aa, Artificial Sequence
  Synthetic peptide
TRREAEDLQVGQVELGGGPGAGSLQPLALEGSLQK

SEQ ID NO: 19 - protein, 35 aa, Artificial Sequence
  Synthetic peptide
TRREAEDLQVGQVELGGGPGAGSLQLPALEGSQKK

SEQ ID NO: 20 - protein, 22 aa, Artificial Sequence
  Synthetic peptide
RGIVEQCCTSICSLYQLENYCN

SEQ ID NO: 21 - protein, 22 aa, Artificial Sequence
  Synthetic peptide
RGIVEQCCTSICSLYQLENCNY

SEQ ID NO: 22 - protein, 19 aa, Artificial Sequence
  Synthetic peptide
MALWMRLLPLLALLALWGP

SEQ ID NO: 23 - protein, 19 aa, Artificial Sequence
  Synthetic peptide
WLMAMRLLPLLALLALWGP

SEQ ID NO: 24 - protein, 40 aa, Artificial Sequence
  Synthetic peptide
DPAAAFVNQHLCGSHLVEALYLVCGERGFFYTPKTRREAE

SEQ ID NO: 25 - protein, 40 aa, Artificial Sequence
  Synthetic peptide
DPAAAFVNQHLCGSHLVEALYLVCGERGFFYTPKTREAER

SEQ ID NO: 26 - protein, 51 aa, Artificial Sequence
  Synthetic peptide
DLQVGQVELGGGPGAGSLQPLALEGSLQKRGIVEQCCTSICSLYQLENYCN

SEQ ID NO: 27 - protein, 51 aa, Artificial Sequence
  Synthetic peptide
DLQVGQVELGGGPGAGSLQPLALEGSLQKRGIVEQCCTSISCLYQLENYCN

SEQ ID NO: 28 - protein, 13 aa, Artificial Sequence
  Synthetic peptide
QCCTSICSLYQLE

SEQ ID NO: 29 - protein, 13 aa, Artificial Sequence
  Synthetic peptide
QCCTSICSLLQYE

SEQ ID NO: 30 - protein, 7 aa, Artificial Sequence
  Synthetic peptide
LQVGQVE

SEQ ID NO: 31 - protein, 7 aa, Artificial Sequence
  Synthetic peptide
LQVQVGE

SEQ ID NO: 32 - protein, 16 aa, Artificial Sequence
  Synthetic peptide
LGGGPGAGSLQPLALE

SEQ ID NO: 33 - protein, 16 aa, Artificial Sequence
  Synthetic peptide
LGPGAGSGLGLQLPAE

SEQ ID NO: 34 - protein, 37 aa, Artificial Sequence
  Synthetic peptide
MALWMRLLPLLALLALWGPDPAAAFVNQHLCGSHLVE

SEQ ID NO: 35 - protein, 37 aa, Artificial Sequence
  Synthetic peptide
MALWMRLLPLLALLALWGPDPAAAFVNQHLCLGVSHE

SEQ ID NO: 36 - protein, 4 aa, Artificial Sequence
  Synthetic peptide
NYCN

SEQ ID NO: 37 - protein, 4 aa, Artificial Sequence
  Synthetic peptide
NCYN

SEQ ID NO: 38 - protein, 8 aa, Artificial Sequence
  Synthetic peptide
ALYLVCGE

SEQ ID NO: 39 - protein, 8 aa, Artificial Sequence
  Synthetic peptide
ALYLCVGE

SEQ ID NO: 40 - protein, 10 aa, Artificial Sequence
  Synthetic peptide
GSLQKRGIVE

SEQ ID NO: 41 - protein, 10 aa, Artificial Sequence
  Synthetic peptide
GSLQKRVGIE

SEQ ID NO: 42 - protein, 12 aa, Artificial Sequence
  Synthetic peptide
RGFFYTPKTRRE

SEQ ID NO: 43 - protein, 12 aa, Artificial Sequence
  Synthetic peptide
RGFFYTPKRRTE

SEQ ID NO: 44 - protein, 59 aa, Artificial Sequence
  Synthetic peptide
MALWMRLLPLLALLALWGPDPAAAFVNQHLCGSHLVEALYLVCGERGFFYTPKTRREAE

SEQ ID NO: 45 - protein, 59 aa, Artificial Sequence
  Synthetic peptide
MALWMRLLPLLALLALWGPDPAAAFVNQHLCGSHLVEALYLVCGERGFFYTPKTREAER

SEQ ID NO: 46 - protein, 27 aa, Artificial Sequence
  Synthetic peptide
DPAAAFVNQHLCGSHLVEALYLVCGER

(19) United States
(12) Patent Application Publication
(10) Pub. No.: US 2016/0275237 A1
(43) Pub. Date: Sep. 22, 2016

(54) AMINO ACID SEQUENCE ANALYZING METHOD AND SYSTEM

(71) Applicant: SHIMADZU CORPORATION, Kyoto-shi (JP)

(72) Inventors: Akiyasu YOSHIZAWA, Kyoto-shi (JP); Takayuki YOSHIMORI, Tokyo (JP)

(73) Assignee: SHIMADZU CORPORATION, Kyoto-shi (JP)

(21) Appl. No.: 14/661,141

(22) Filed: Mar. 18, 2015

(51) Int. Cl. G06F 19/16; H01J 49/00

(52) U.S. Cl. CPC G06F 19/16; H01J 49/0036

(57) ABSTRACT

Peptide-fragment mixtures obtained by fragmenting a sample with each of multiple enzymes which cause cleavage at different sites are subjected to mass spectrometry. De novo sequencing is performed on the obtained results to deduce partial sequence candidates for various kinds of fragments (S1 and S2). Using the fact that a specific amino acid residue should appear at the cleavage site depending on the enzyme, a partial sequence candidate including the terminal of the original amino acid sequence is extracted from a number of candidates (S6). The task of searching for and combining non-terminal partial sequence candidates including an overlapping portion is repeated (S7 and S8). The sequence candidates including the terminal are subsequently connected to the ends of the sequence obtained through the repetitive task (S9). The eventually obtained amino acid sequence is highly likely to be the correct solution (S10 and S11).

### TECHNICAL FIELD

The present invention relates to a method and system for analyzing an amino acid sequence by performing a mass spectrometry of a target sample containing a peptide mixture and deducing the amino acid sequence of a peptide contained in the target sample using mass spectrum data obtained by the mass spectrometry.

### BACKGROUND ART

In recent years, structural and functional analyses of proteins have been rapidly promoted as post-genome research. As one method for such structural and functional analyses of proteins (proteome analyses), an expression analysis or primary structure analysis of a protein using a mass spectrometer has been widely performed. In this context, a so-called MSⁿ analysis (where n is an integer equal to or greater than two) including the steps of selecting and capturing a specific kind of ion and breaking this ion into fragments by collision induced dissociation (CID) or similar process has proven itself to be effective. Generally, in an MS² (=MS/MS) analysis, an ion having a specific mass-to-charge ratio m/z is first selected as a precursor ion from the analysis target. Then, the precursor ion is fragmented by CID. Subsequently, the ions (product ions) generated by the fragmentation are subjected to a mass spectrometry to obtain information on the mass and the chemical structure of the target ion.

In the case of identifying the amino acid sequence of a protein by an MSⁿ analysis, the protein is first digested with an appropriate enzyme so as to cut a bond or bonds in the amino acid sequence and thereby break it into a mixture of peptide fragments, and then the peptide mixture is subjected to a mass spectrometry. Since the elements constituting each peptide have stable isotopes with different masses, even peptides having the same amino acid sequence generate a plurality of peaks of different mass-to-charge ratios due to the difference of their isotope composition. The plurality of peaks include the peak of the main ion (i.e. the ion composed only of the isotopes having the largest natural abundance ratio) and those of the isotopic ions (the ions which contain the other isotopes). In the case of a singly-charged ion, these peaks form an isotopic peak group including a plurality of peaks located at intervals of 1 Da.

Subsequently, from the mass spectrum data thus acquired for the peptide mixture, a group of isotopic peaks originating from one peptide are selected as precursor ions. The precursor ions are fragmented and the resultant ions (product ions) are subjected to a mass spectrometry (MS² analysis). If the precursor ions are not broken into sufficiently small fragments by a single fragmenting operation, the fragmenting operation may be repeated a plurality of times.

Based on the mass spectrum pattern of the product ions obtained in the previously described manner or the mass spectrum pattern of the previously mentioned precursor ions, a database search for amino acid sequence identification is performed using a search engine, such as “MASCOT,” which is a system offered by Matrix Science Ltd. Specifically, the mass-to-charge ratio of each peak obtained by an actual measurement is compared with those of the product ions calculated from proteins registered in a database, to find a protein which has the highest degree of matching. Using the search result, the amino acid sequence of the test peptide can be determined.

However, this method cannot be used for the identification of new proteins which are not registered in the database. In such a case, a method called “de novo sequencing” is popularly used. Roughly speaking, de novo sequencing is a method for deducing the amino acid sequence of a test peptide by searching for an amino acid having a mass-to-charge ratio which corresponds to the difference in the mass-to-charge ratio of a plurality of peaks appearing on the mass spectrum. Specific search algorithms for this method have conventionally been studied in many institutes and organizations, and various methods have been proposed, such as a method using the graph theory and a method using the technique of dynamic programming (see Patent Literature 1 and Non Patent Literature 1).

For example, in the method described in Patent Literature 1, which is an improved version of the technique described in Non Patent Literature 1, when amino acid sequence candidates are to be selected based on mass spectrum data, the problem of finding an amino acid sequence candidate which gives the highest value of a score that indicates the reliability of the candidate is formulated as a longest path problem on a two-dimensional acyclic graph with one axis representing the position in an amino acid sequence and the other axis indicating the mass-to-charge ratio on the mass spectrum. Based on a peak list in which the mass-to-charge ratios and the signal intensities of the peaks originating from the test peptide are collected, path searches are performed and the signal intensities of the peaks on each path are added to obtain a score for the path. After the search has reached the terminal of the paths, each path with a high score is selected and followed backwards. During this backward process, each amino acid located on the path is identified so as to determine the amino acid sequence.

By the previously described dynamic programming, it is possible to list a plurality of amino acid sequences as candidates by selecting not only the path giving the highest score but also some other paths giving significantly high scores in the initially conducted path search, and then following each path backwards to determine the corresponding amino acid sequence. Listing a large number of amino acid sequence candidates in this manner can prevent the amino acid sequence which is actually the correct solution from being omitted from the detected candidates. However, according to a study by the present inventors, even if a precise score is calculated, the amino acid sequence which is actually the correct solution does not always achieve a high rank. Therefore, this method is not always effective enough to provide users with useful information for amino acid sequence analysis.

To solve the previously described problem, the present inventors have proposed a new algorithm for deducing an amino acid sequence by de novo sequencing, as disclosed in Patent Literature 2. In this new method, an amino acid sequence is deduced after the amino acid composition information of the measurement target obtained by another method (e.g. an amino acid analyzer) and the conditions on the amino acid sequence candidates are specified. To this end, the problem of finding amino acid sequence candidates is formulated as a longest path problem on a directed graph having a tree structure in which an amino acid sequence composed of k amino acids is placed at each node at the kth depth. The amino acid sequence is determined using the so-called branch and bound approach. This method also provides a plurality of amino acid sequence candidates which absolutely include the correct solution. Normally, the amino acid sequence which is the correct solution is strongly expected to score high.

### CITATION LIST

### Patent Literature

Patent Literature 1: JP 2008-145221 A
Patent Literature 2: JP 2013-160595 A

### Non Patent Literature

Non Patent Literature 1: Bin Ma et al., “An effective algorithm for peptide de novo sequencing from MS/MS Spectra”, Journal of Computer and System Sciences, 2005, Vol. 70, pp. 418-430
Non Patent Literature 2: F. Sanger et al., “Nucleotide Sequence of Bacteriophage lambda DNA”, Journal of Molecular Biology, 1982, Vol. 162, pp. 729-773
Non Patent Literature 3: E. W. Myers, “Toward Simplifying and Accurately Formulating Fragment Assembly”, Journal of Computational Biology, 1995, Vol. 2, pp. 275-290
Non Patent Literature 4: N. Bandeira et al., “Shotgun Protein Sequencing”, Molecular & Cellular Proteomics, 2007, Vol. 6, pp. 1123-1134
Non Patent Literature 5: G. Mazzucchelli et al., “Efficient and rapid multienzymatic limited digestion (MELD) method for complete protein characterization and bottom-up de novo sequencing”, the preliminary draft for poster session PMo-038 at the 19th International Mass Spectrometry Conference, 2012

### SUMMARY OF INVENTION

### Technical Problem

As another approach to the sequence deduction by de novo sequencing, a method using the majority vote algorithm is commonly known. This method was originally invented for the determination of nucleic acid sequences and has been further improved. Its basic idea is to increase the reliability of a base sequence by overlapping partial sequences included in shorter base sequences determined by a DNA sequencer, thus superposing a large number of base sequences and producing a consensus (by majority vote). Sanger et al. was the first to publish this technique, who disclosed in Non Patent Literature 2 an experimental method for the technique as well as the nucleic acid sequence of a gene determined by the technique. Later on, Myers proposed a computer-oriented algorithm based on that technique (Non Patent Literature 3). An assembler program for nucleic acid sequences known as “Celera Assembler” is also based on the same technique.

While the aforementioned algorithm was originally designed for DNA (or RNA) base sequences, the idea of applying this algorithm to amino acid sequences determined by de novo sequencing has also been proposed. One example is disclosed in Non Patent Literature 4, in which a number of peaks extracted from mass spectra are superposed on each other (this operation is called the “Spectral alignment” in Non Patent Literature 4) before the deduction of the amino acid sequence so as to increase the reliability of the mass spectrum itself, after which the deduction of the amino acid sequence by de novo sequencing is performed on the mass spectrum. This technique is aimed at reducing fluctuations of the results inherent in the measurement and thereby improving the reliability of the deduction by de novo sequencing itself, particularly the reliability of the deduction of the modified amino acid sequences.

FIG. 9 shows an example of the “Spectral alignment” disclosed in Non Patent Literature 4. In this figure, (a) shows the amino acid sequence which is the correct solution for a peptide which is the measurement target, and (b) shows the mass-to-charge ratio difference between the b-ion peaks extracted from mass spectra obtained in each of a plurality of measurements performed on the peptide sample. Although some specific b-ions are missing from the observed result in some of the measurements, the presence of all the b-ions corresponding to the existing amino acids can be confirmed by performing the measurement a greater number of times and superposing the obtained results. Different results may be obtained in the measurements, for example, as in case (b) of FIG. 9 in which the b-ion corresponding to methionine and the b-ion corresponding to oxidized methionine have been obtained. In such a case, the b-ion corresponding to methionine can be adopted by producing a consensus by majority vote.

However, adopting the majority vote algorithm in an amino acid sequence deduction by de novo sequencing does not always produce such satisfactory effects as anticipated. The reasons are as follows:

Consider the case where the reconstruction technique using the overlapping operation as proposed by Myers et al. is applied in deducing the base sequence of DNA. Because DNAs have only four kinds of bases (adenine, guanine, thymine and cytosine), the exclusive cause of incorrect deduction of the base sequence is the measurement error. Since larger measurement errors are less likely to occur, it is possible to exclude incorrect sequences and deduce the sequence which is the correct solution by performing the measurement a larger number of times and adopting a sequence candidate which has most frequently occurred.

In the case of deducing an amino acid sequence by de novo sequencing based on the result obtained by mass spectrometry, there are two major causes of incorrect deduction of the sequence as follows:

Firstly, in the course of the measurement (mass spectrometry), the ion to be analyzed may fail to generate, which leads to omission in the measurement.

Secondly, in the stage of deducing a sequence from the peaks on the mass spectra obtained as the measurement result, the correct solution may be discarded due to some constraint of the applied algorithm, such as the dynamic programming.

The error of the sequence deduction caused by (1) can be reduced by increasing the number of times of the measurement. By contrast, increasing the number of times of the measurement does not guarantee that the sequence deduction error caused by (2) will be reduced, since cause (2) is not a stochastic problem.

Non Patent Literature 5 discloses a technique for deducing the amino acid sequence of a target sample which is a kind of protein. In this technique, the target sample is broken into fragments by simultaneously using multiple digestive enzymes. The fragmented sample is subjected to a mass spectrometry, and the obtained mass spectrum is subjected to de novo sequencing. The aforementioned literature is mainly concerned about how to control the enzymatic digestion time and thereby intentionally introduce a “missed cleavage”, i.e. “a site at which the protein should have been cleaved but has not actually been cleaved due to insufficient enzymatic digestion”, so as to control the entire lengths of the peptides resulting from the digestion. It contains no description about specific methods for deducing amino acid sequences by performing de novo sequencing on the obtained mass spectrum.

The present invention has been developed in view of the previously described problems. Its primary objective is to improve the reliability of the amino acid sequence deduction by appropriately using the reconstruction technique employing the overlapping operation, in an amino acid sequence analyzing method and system for performing de novo sequencing on the result of a mass spectrometry and for deducing an amino acid sequence.

### Solution to Problem

The first aspect of the present invention aimed at solving the previously described problem is an amino acid sequence analyzing method for deducing the amino acid sequence of a target sample which is a polypeptide based on mass spectrum data collected by a mass spectrometry performed on a mixture of peptide fragments obtained by fragmenting the sample with an enzyme, the method including:

a) a partial sequence deduction step, in which, for mass spectrum data collected by performing a mass spectrometry on each of a plurality of kinds of peptide-fragment mixtures prepared by performing a fragmentation using a single kind of enzyme on the target sample for each of a plurality of kinds of enzymes, a partial amino acid sequence candidate corresponding to each fragment is determined by a sequence deduction using de novo sequencing;

b) a data collection step, in which information about the kind of enzyme used for the fragmentation and the partial amino acid sequence candidates determined in the partial sequence deduction step are collected;

c) a terminal sequence extraction step, in which a partial amino acid sequence including an N-terminal or C-terminal of the original polypeptide is extracted based on the partial amino acid sequence candidates and the enzyme information, using the fact that a cleavage occurs at a previously known specific site corresponding to the kind of enzyme;

d) a combining process execution step, in which an amino acid sequence candidate is derived by extending an amino acid sequence through a repetition of the task of selecting and combining only such partial amino acid sequence candidates that can be consistently overlapped at common partial sequences included in the partial amino acid sequence candidates, exclusive of the partial amino acid sequence candidates including the N-terminal or C-terminal, and by eventually combining the partial amino acid sequence including the terminal extracted in the terminal sequence extraction step;

e) a result check step, in which the number of partial amino acid sequence candidates used in the combining process is calculated for every amino acid sequence candidate created in the combining process execution step, and in which one or more amino acid sequence candidates are selected or ranked based on the calculated numbers; and

f) a result presentation step, in which the one or more amino acid sequence candidates selected or ranked in the result check step are presented as a deduction result of the amino acid sequence of the target sample.

The amino acid sequence analyzing system according to the second aspect of the present invention is a system for realizing the amino acid sequence analyzing method according to the first aspect of the present invention on a computer. That is to say, it is a system for deducing the amino acid sequence of a target sample which is a polypeptide based on mass spectrum data collected by performing a mass spectrometry on each of a plurality of kinds of peptide-fragment mixtures prepared by performing a fragmentation using a single kind of enzyme on the sample for each of a plurality of kinds of enzymes, the system including:

a) a partial sequence deducer for deducing, for mass spectrum data obtained for each of the plurality of kinds of peptide-fragment mixtures, a partial amino acid sequence candidate corresponding to each fragment by a sequence deduction using de novo sequencing;

b) a data collector for collecting information about the kind of enzyme used for the fragmentation and the partial amino acid sequence candidates determined by the partial sequence deducer;

c) a terminal sequence extractor for extracting a partial amino acid sequence including an N-terminal or C-terminal of the original polypeptide based on the partial amino acid sequence candidates and the enzyme information, using the fact that a cleavage occurs at a previously known specific site corresponding to the kind of enzyme;

d) a combining process executer for deriving an amino acid sequence by extending an amino acid sequence through a repetition of the task of selecting and combining only such partial amino acid sequence candidates that can be consistently overlapped at common partial sequences included in the partial amino acid sequence candidates, exclusive of the partial amino acid sequence candidates including the N-terminal or C-terminal, and by eventually combining the partial amino acid sequence including the terminal extracted by the terminal sequence extractor;

e) a result checker for calculating the number of partial amino acid sequence candidates used in the combining process for every amino acid sequence candidate created by the combining process executor, and for selecting or ranking one or more amino acid sequence candidates based on the calculated numbers; and

f) a result presenter for presenting the one or more amino acid sequence candidates selected or ranked by the result checker as a deduction result of the amino acid sequence of the target sample.

When the amino acid sequence analyzing method according to the first aspect of the present invention which is embodied by the amino acid sequence analyzing system according to the second aspect of the present invention is to be applied, a plurality of kinds of peptide-fragment mixtures are individually prepared by a fragmentation of the polypeptide of a target sample using a single kind of digestive enzyme for each of a plurality of kinds of digestive enzymes, and each mixture is individually subjected to a mass spectrometry to collect mass spectrum data. There are various kinds of digestive enzymes and it is known that each enzyme causes a cleavage at a specific bonding site in an amino acid sequence, or more specifically, at a peptide bond located on either the carboxyl-group side or the amino-group side of the amino acid residue. Accordingly, by performing a mass spectrometry on each of the samples respectively fragmented by different kinds of enzymes, ion intensity data can be obtained for each different set of peptide fragments produced by breaking the amino acid bonds at various sites in the amino acid sequence of the target sample. It should be noted the “polypeptide” in the present description is used as a general term for proteins and peptides.

In the amino acid sequence analyzing method according to the first aspect of the present invention, the mass spectrum data prepared in the previously described manner are subjected to a sequence deduction using de novo sequencing in the partial sequence deduction step so as to find partial amino acid sequence candidates for each peptide fragment. The partial amino acid sequence candidates found in this step may include incorrectly deduced, false candidates, but they absolutely need to include a partial amino acid sequence which is the correct solution. Accordingly, in this step, it is particularly necessary to use an algorithm that will never (or barely) allow the partial amino acid sequence which is the correct solution to be omitted from the deduced result. A study by the present inventors has confirmed that a deduction result in which a partial amino acid sequence that is the correct solution is always included among a plurality of partial amino acid sequence candidates can be obtained by performing the de novo sequencing according to the algorithm proposed in Patent Literature 2.

As noted earlier, the bonding site at which the cleavage occurs in an amino acid sequence depends on the kind of enzyme, and that bonding site is previously known. Accordingly, in the terminal sequence extraction step, one or more partial amino acid sequence candidates which include the C-terminal or N-terminal of the original polypeptide (before cleavage) are identified among the collected candidates, with the help of the collected enzyme information and the previously known information. Specifically, for example, if a partial amino acid sequence which has resulted from the cleavage of an amino acid sequence with a certain kind of enzyme does not have, at its ends, an amino acid residue that should appear at the cleavage site caused by that enzyme, it is possible to determine that this partial amino acid sequence candidate probably includes the terminal. For another example, if a comparison of the results obtained by fragmentations with multiple kinds of enzymes which differ from each other in their specificity to the cleavage site has revealed that there are a plurality of partial amino acid sequences having the same amino acid residue at their end portions, it is possible to determine that those portions are most likely to be the terminal.

Partial amino acid sequence candidates include partial amino acid sequences corresponding to peptide fragments which have been cut at various sites. Therefore, two predetermined partial amino acid sequences which are correct solutions should partially match each other, i.e. they should have an overlapping portion. Accordingly, by overlapping this partial portion, the two partial amino acid sequences can be combined together. If both partial amino acid sequences are correctly deduced sequences, the two sequences can be consistently overlapped. If one or both of the partial amino acid sequences are incorrectly deduced sequences and hence incorrect solutions, the probability that they can accidentally overlap is considerably low but not low enough to be ignored. However, in the case where a greater number of partial amino acid sequences are combined together to find an amino acid sequence which covers the entire length of the original polypeptide, the probability of an accidental combination of incorrectly deduced sequences can be lowered to extremely low levels by repeating the operation of searching for an overlapping portion and combining the partial amino acid sequence candidates in which the overlapping portion has been found. This is due to the fact that the probability of an accidental combination of incorrectly deduced sequences exponentially decreases every time two partial amino acid sequence candidates are combined together by overlapping their partial sequence.

In the combining process execution step, the previously described task of combining partial amino acid sequence candidates is repeated, and eventually, a partial amino acid sequence which includes the terminal is similarly combined to derive a candidate of the amino acid sequence corresponding to the entire length of the polypeptide of the target sample. Two or more candidates may be thereby obtained. From the previously described point of view, a candidate derived from the combination of a greater number of partial amino acid sequence candidates is more likely to be the correct solution. Accordingly, in the result check step, the number of partial amino acid sequence candidates used in the combining process is calculated for every amino acid sequence candidate obtained by the combining process, and based on the calculated numbers, those amino acid sequence candidates are selected or ranked. Specifically, for example, it is possible to select any candidate derived from more than a predetermined number of combined partial amino acid sequence candidates, or to rank the candidates in descending order of the number of combined partial amino acid sequence candidates and then remove any candidate derived from less than a predetermined number of combined partial acid sequence candidates. In the result presentation step, the selected or ranked amino acid sequence candidates are shown on the screen of a display unit, or in some other presentation form, as a deduction result of the amino acid sequence of the target sample.

The first and second aspects of the present invention are characterized in that they make use of the fact that the process of reconstructing the amino acid sequence of the original polypeptide (before cleavage) by finding and combining an overlapping portion of a plurality of partial amino acid sequence candidates has the effect of “allowing the reconstruction process to be performed using only such partial amino acid sequences that are correct solutions”, instead of producing a consensus among the amino acid sequences deduced by de novo sequencing. That is to say, the process of repeatedly combining two partial amino acid sequence candidates with a portion of their sequences overlapped excludes incorrectly deduced, false candidates of the sequence, allowing such amino acid sequences that are most likely to be the correct solution to eventually remain as the reconstructed results.

In a preferable mode of the amino acid sequence analyzing method according to the first aspect of the present invention, the amino acid sequence candidates are narrowed down in the result check step, based on amino acid compositions derived from the amino acid sequence candidates created in the combining process execution step and based on known amino acid composition information of the target sample.

For example, the known amino acid composition information of the target sample is information on the amino acid composition, i.e. the kinds and numbers of amino acids, obtained from the result of an analysis of the polypeptide which is the target sample using a mass spectrometer or some other type of analyzer. A mass spectrometer capable of measuring the mass of a target sample with an extremely high level of accuracy can calculate the amino acid composition information from the measured mass. The amino acid composition information can also be obtained with an appropriate analyzer, such as the LC/MS Ultra-Fast Amino Acid Analysis System “UF-Amino Station” manufactured by Shimadzu Corporation.

If a repetition of a specific sequence exists in the original amino acid sequence, the length of the overlapping portion may be incorrectly determined in the combining process execution step due to the repetition of that sequence. Using the amino acid composition information in the previously described manner excludes sequences that have been deduced based on such an incorrectly determined length, whereby the deduction accuracy of the amino acid sequence is even further improved.

### Advantageous Effects of the Invention

With the amino acid sequence analyzing method according to the first aspect of the present invention and the amino acid sequence analyzing system according to the second aspect of the present invention, the deduction accuracy of the amino acid sequence of a protein or peptide can be improved. In particular, only one or a small number of amino acid sequence candidates which are most likely to be the correct solutions can be presented in place of a considerable number of candidates including an amino acid sequence which is the correct solution. Thus, more useful information will be presented to analysis operators than that provided by conventional systems of this type. Even the amino acid sequence of an unknown protein or peptide which is not registered in a search database can be deduced, since the sequence deduction in the first and second aspects of the present invention is basically performed using de novo sequencing.

### BRIEF DESCRIPTION OF DRAWINGS

FIG. 1 is a block configuration diagram of an amino acid sequence analyzing system according to one embodiment of the present invention.

FIG. 2 is a flowchart showing the steps of the tasks and processes of the amino acid sequence analyzing method carried out in the amino acid sequence analyzing system of the present embodiment.

FIG. 3 is a conceptual diagram of the method for combining partial amino acid sequence candidates in the amino acid sequence analyzing method of the present embodiment.

FIG. 4 is an explanatory diagram specifically showing the method for reconstructing the amino acid sequence of a polypeptide sample while repeating the checking by combining partial amino acid sequence candidates.

FIG. 5 shows one example of the input format of the partial amino acid sequence candidates in the amino acid sequence analyzing method of the present embodiment.

FIG. 6 shows one example of the digestive enzymes and partial amino acid sequence candidates which are the target of the data processing in the amino acid sequence analyzing method of the present embodiment.

FIG. 7 is an explanatory diagram showing the process of extracting partial amino acid sequences including the C-terminal in the amino acid sequence analyzing method of the present embodiment.

FIG. 8 is an explanatory diagram showing the process of combining partial amino acid sequences which do not include the C/N-terminal in the amino acid sequence analyzing method of the present embodiment.

FIG. 9 shows one example of the “Spectral alignment” disclosed in Non Patent Literature 4.

### DESCRIPTION OF EMBODIMENTS

One embodiment of the amino acid sequence analyzing system using the amino acid sequence analyzing method according to the present invention is hereinafter described with reference to the attached drawings.

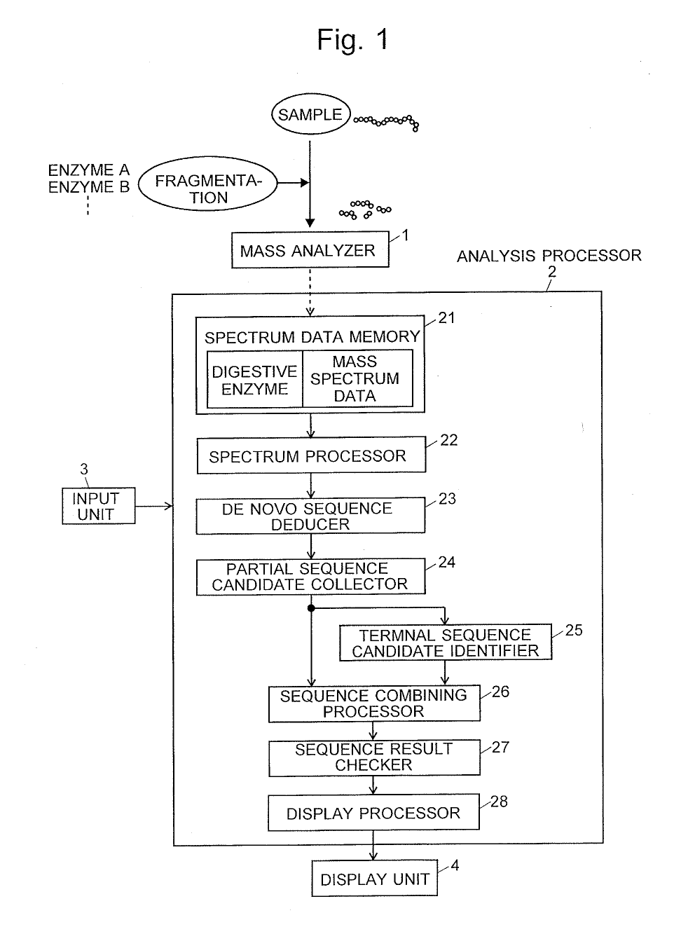

FIG. 1 is a block configuration diagram of the amino acid sequence analyzing system according to the present embodiment.

The amino acid sequence analyzing system of the present embodiment consists of an analysis processor unit 2 as well as an input unit 3 and a display unit 4, both of which are connected to the analysis processor unit 2. The analysis processor unit 2 includes a spectrum data memory 21, a spectrum processor 22, a de novo sequence deducer 23, a partial sequence candidate collector 24, a terminal sequence candidate identifier 25, a sequence combining processor 26, a sequence result checker 27 and a display processor 28. The mass analyzer 1 is an MSⁿ mass spectrometer (n is an integer equal to or greater than two), e.g. a MALDI ion trap TOFMS. Mass spectrum data obtained by performing a mass spectrometry (MSⁿ analysis) on a peptide-fragment mixture prepared from a sample which contains a test peptide to be analyzed are stored in the spectrum data memory 21. In the analysis processor unit 2, the amino acid sequence of the test peptide is deduced by an analyzing process using those mass spectrum data. Any mass spectrometer which is at least capable of an MS² analysis can be used as the mass analyzer 1.

The present system is actually a computer and is embodied by executing an amino acid sequence analysis program on that computer. This program may be a program loaded from a storage medium into the computer or a program retrieved from outside through communication networks or the like. The storage medium may be a removable medium, such as a CD (e.g. CD-ROM, CD-R or CD-RW), MO, DVD-RAM, or memory card, or it may be a HDD or similar device which is normally fixed and cannot be easily removed.

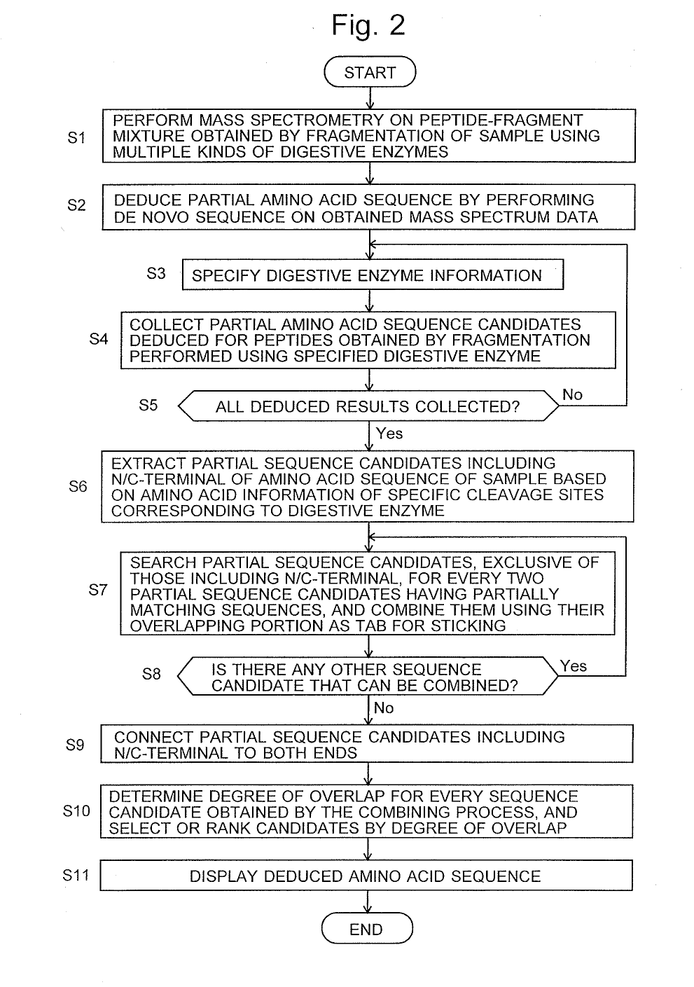

FIG. 2 is a flowchart showing the steps of the tasks and processes of deducing the amino acid sequence of a sample by the amino acid sequence analyzing system of the present embodiment.

To perform a mass spectrometry using the mass analyzer 1, the sample is fragmented beforehand with an appropriate kind of digestive enzyme. In an amino acid sequence deduction according to the present embodiment, a plurality of fragmentation treatments using different kinds of enzymes A, B, and so on, are performed to prepare a plurality of kinds of peptide-fragment mixtures, respectively, and a mass spectrometry is performed on each of those mixtures (Step S1). One example of the digestive enzyme available in the present invention is an endopeptidase which has a high degree of substrate specificity and thereby specifically or preferentially cleaves a peptide bond on the carboxyl-group side or amino-group side of a specific kind of amino acid. Specific examples include trypsin, Lys-C, Asp-N and V8. As a result of the mass spectrometry, a set of mass spectrum data are stored in the spectrum data memory 21 for each enzyme used.

As one example, the following description deals with the case where the unknown sample is insulin and four kinds of digestive enzymes as follows are used: trypsin, Lys-C, Asp-N and V8 (under a buffer solution of sodium phosphate). Using a different kind of enzyme causes the sample to be cleaved at different bonding sites in the fragmentation process. Accordingly, a totally different set of mass spectrum data is collected for each enzyme.

Next, for each enzyme, the spectrum processor 22 reads mass spectrum data from the spectrum data memory 21, creates a mass spectrum, and performs a peak detection. The de novo sequence deducer 23 performs de novo sequencing, using the mass-to-charge ratio information of the detected peaks, to deduce a partial amino acid sequence corresponding to each peptide fragment and select it as a partial amino acid sequence candidate (Step S2).

For the deduction of a partial amino acid sequence by de novo sequencing, the new technique proposed in Patent Literature 2 by the present inventors can be conveniently used.

In this new technique, the problem of finding an amino acid sequence candidate is formulated as a longest path problem on a directed graph having a tree structure with each node at the kth depth representing one amino acid sequence composed of k amino acids and each branch representing the peak intensity corresponding to an amino acid in the peak list. Known information relating to the amino acid composition of the sample is imposed as the constraint conditions on the amino acids arranged on the tree. With the graph thus prepared, the amino acid sequence is determined using the so-called branch and bound approach.

Specifically, the tree-structured directed graph is developed as follows: A sequence having one amino acid at one terminal is placed at the root node. For every step toward the deeper levels in the tree structure, one amino acid is additionally placed, with the placement position alternately changed between the two terminals and sequentially shifted inwards. This branching operation is limited by imposing constraints corresponding to the kinds and numbers of amino acids derived from the amino acid composition information. For every path being searched, a score is calculated from the intensities assigned to the branches on the path, and the final score is predicted from the remaining amino acids during the search. If the predicted score is low, the search of that path is discontinued for the purpose of pruning Thus, the number of search paths is decreased while avoiding an omission of the correct sequence candidates.

In the previously described technique, amino acid composition information obtained with an amino acid analyzer or similar system must be inputted in addition to the mass spectrum data. For example, the amino acid composition can also be obtained with the LC/MS Ultra-Fast Amino Acid Analysis System “UF-Amino Station” manufactured by Shimadzu Corporation or a similar analyzer. It is also possible to calculate the composition from the mass-to-charge ratio of the test peptide obtained with a mass spectrometer having an extremely high level of mass accuracy.

Naturally, the method for determining partial amino acid sequence candidates by de novo sequencing is not limited to the previously described one; any technique can be used as long as it guarantees that the sequences which are correct solutions will be included in the deduced sequence candidates with a high probability.

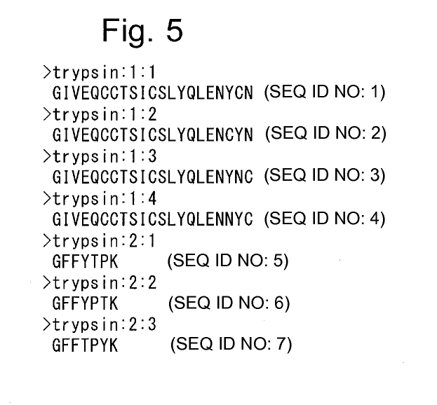

Next, for each of the enzymes corresponding to the mass spectrum data based on which the deduction by de novo sequencing was made, the partial sequence candidate collector 24 reads partial amino acid sequence candidates obtained as a result of the deduction. To this end, initially, the name of the digestive enzyme is specified (Step S3), and subsequently, the partial amino acid sequence candidates obtained from the mass spectrum data corresponding to that enzyme are retrieved from the de novo sequence deducer 23 (Step S4). Then, whether or not all the sequence deduction results have been received is determined (Step S5). If there is any sequence deduction result remaining, the operation returns to Step S3 and a sequence deduction result corresponding to another enzyme is received. If the multiFASTA format, an example of which is shown in FIG. 5, is used as the data notation system for amino acid sequences, all the partial amino acid sequence candidates can be read at one time.

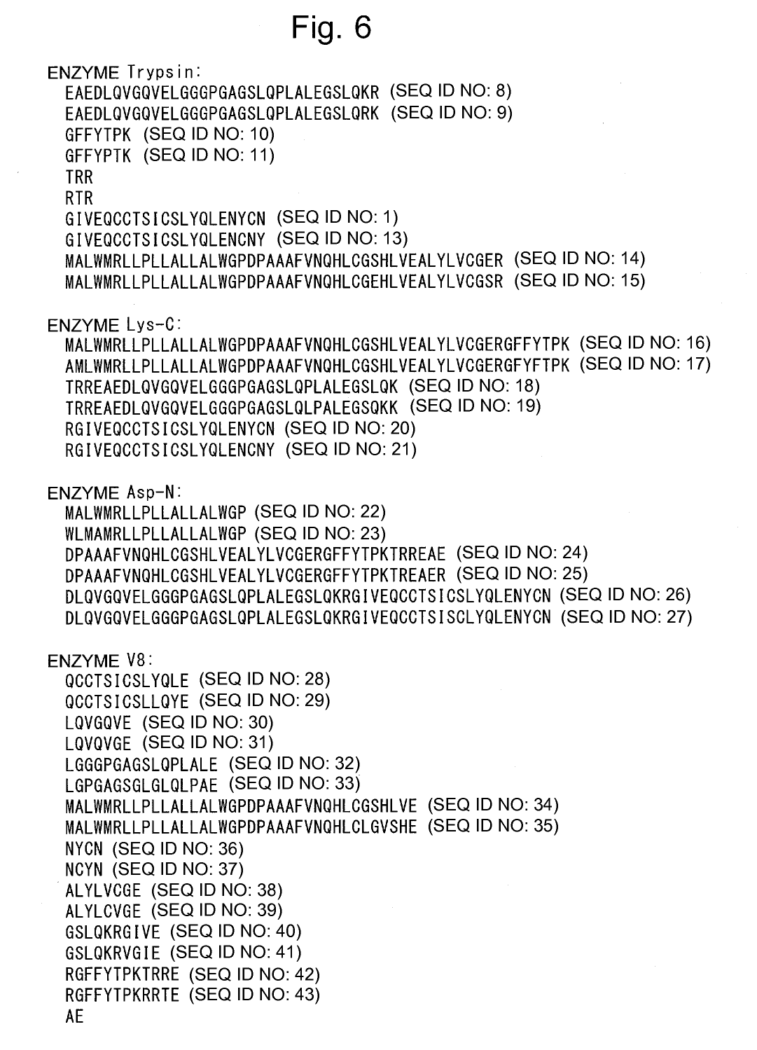

FIG. 6 shows one example of all the amino acid sequence candidates read by the processes of Steps S3-S5. The four groups of partial amino acid sequence candidates shown in FIG. 6, from top to bottom, were obtained using trypsin, Lys-C, Asp-N and V8, respectively. The following description deals with the case where two partial amino acid sequence candidates have been obtained for each mass spectrum, as shown in FIG. 6.

From these partial amino acid sequence candidates, the terminal sequence candidate identifier 25 extracts partial amino acid sequence candidates including the N-terminal of the amino acid sequence of the sample before the fragmentation by digestive enzymes, as well as those including the C-terminal (Step S6). This is achieved using information about the sites at which the cleavage specifically occurs depending on the enzyme. More specifically, whether or not a given partial amino acid sequence includes the terminal of the original sequence is determined based on two conditions as follows:

### Condition 1

The digestive enzyme used in the present invention has the characteristic that it recognizes a specific amino acid residue in an amino acid sequence and preferentially or specifically breaks the peptide bond on the carboxyl-group side or amino-group side of that specific amino acid residue. Based on this fact, if a peptide fragment obtained by cleaving an amino acid sequence with a certain kind of enzyme does not have, at its end portion, a specific amino acid residue that should absolutely appear at the end portion on the C-terminal or N-terminal side of the amino acid sequence of the peptide fragment after the cleavage with that enzyme, that portion (i.e. the end portion of the partial amino acid sequence) is considered to be the terminal of the amino acid sequence of the sample.

### Condition 2

If a comparison of partial amino acid sequence candidates derived from peptide-fragment mixtures produced by cleaving an amino acid sequence with multiple digestive enzymes which differ from each other in their specificity to the cleavage site has revealed that those partial amino acid sequences have the same sequence at their end portions, those portions (i.e. the end portions of the partial amino acid sequences) are considered to be the terminal of the amino acid sequence of the sample.

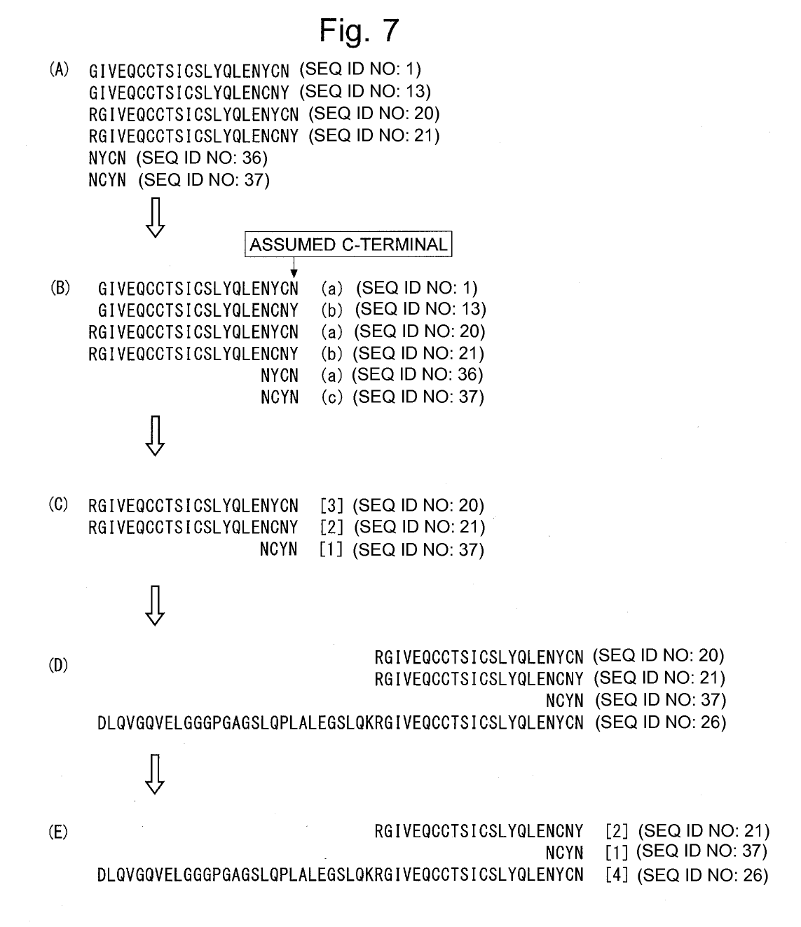

List (A) in FIG. 7 shows one example of the case which satisfies <Condition 1>. This list shows partial amino acid sequences which have been selected from the partial amino acid sequence candidates shown in FIG. 6, and in each of which the amino acid residue at the C-terminal is different from the amino acid residue that should be present at the cleavage site specific to the digestive enzyme used.

That is to say, when trypsin is used as the digestive enzyme, the polypeptide chain is cleaved on the C-terminal side of the lysine (K) or arginine (R) residue, so that either K or R should appear on the C-terminal end, or at the right end, of the peptide fragment after the cleavage. However, in the two partial amino acid sequence candidates [GIVEQCCTSICSLYQLENYCN] and [GIVEQCCTSICSLYQLENCNY] obtained for one mass spectrum, the amino acid residues located at their right ends are N and Y, respectively, which are neither K nor R. This fact suggests that these candidates may possibly be the C-terminal of the amino acid sequence of the sample.

Similarly, when Lys-C is used as the digestive enzyme, lysine (K) should appear on the C-terminal side, or at the right end, of the partial amino acid sequence. Therefore, the two partial amino acid sequence candidates which do not satisfy this condition, i.e. [RGIVEQCCTSICSLYQLENYCN] and [RGIVEQCCTSICSLYQLENCNY], may possibly be the C-terminal of the amino acid sequence of the sample.

When V8 is used as the digestive enzyme under the buffer solution of sodium phosphate, either aspartic acid (D) or glutamic acid (E) should appear on the C-terminal side, or at the right end, of the partial amino acid sequence. Accordingly, the two partial amino acid sequence candidates which do not satisfy this condition, i.e. [NYCN] and [NCYN], may possibly be the C-terminal of the amino acid sequence of the sample.

When Asp-N is used as the digestive enzyme, aspartic acid (D) should appear on the N-terminal side, or at the left end, of the partial amino acid sequence. This characteristic is not related to the C-terminal and therefore will be disregarded for the time being.

Lists (B) and (C) in FIG. 7 show one example of the case where the partial amino acid sequences extracted under <Condition 1> are examined based on <Condition 2> to find a partial amino acid sequence which possibly includes the terminal of the amino acid sequence of the sample. In list (B), the six partial amino acid sequence candidates extracted in the previously described way are arranged in the right justified form, on the assumption that the C-terminal side, or the right end, of those candidates are the C-terminal of the amino acid sequence of the sample. It can be seen that those partial amino acid sequence candidates have three patterns of sequence in the arrangement of the four rightmost letters (four amino acid residues), as denoted by “(a)”, ‘(b)” or “(c)” on the right side of each row. That is to say, (a) is [NYCN], (b) is [NCNY] and (c) is [NCYN].

Incorporating the patterns common to these sequences into the longest partial amino acid sequence candidate results in list (C) in FIG. 7. That is to say, the partial amino acid sequence candidate in the topmost row, [RGIVEQCCTSICSLYQLENYCN], is the result obtained by combining three partial amino acid sequence candidates into one, as indicated by the number in square brackets on the right side of the row. In other words, this sequence has two other partial amino acid sequence candidates incorporated in it. Similarly, the partial amino acid sequence candidate on the second row, [RGIVEQCCTSICSLYQLENCNY], is the result obtained by combining two partial amino acid sequence candidates into one, or by incorporating another partial amino acid sequence candidate. The partial amino acid sequence candidate on the bottom row, [NCYN], is the sequence which has not been combined with any other partial amino acid sequence candidate. Those three sequences are the candidates of the partial amino acid sequence including the C-terminal of the amino acid sequence of the sample. Among those candidates, the one having the largest number of partial amino acid sequence candidates combined together is judged to have the highest probability of being the correct solution as the partial amino acid sequence including the C-terminal of the amino acid sequence of the sample. In the present example, the sequence in the topmost row, [RGIVEQCCTSICSLYQLENYCN], which has three partial amino acid sequence candidates combined together, is judged to be the most reliable solution.

Next, all the other partial amino acid sequence candidates which have been excluded from consideration thus far are searched for any partial amino acid sequence which includes a portion that matches the three partial amino acid sequence candidates shown in list (C) in FIG. 7 (i.e. which entirely includes any of the three sequences, or conversely, which is entirely included in any of the three sequences). In the present example, as already described, the partial amino acid sequence sequences which may possibly include the C-terminal have already been selected from the partial amino acid sequence candidates corresponding to the three digestive enzymes of trypsin, Lys-C and V8. Accordingly, the present task is to search the partial amino acid sequence candidates corresponding to the fragments obtained using Asp-N as the digestive enzyme, for a partial amino acid sequence which includes a matching portion.

In list (D) in FIG. 7, the partial amino acid sequence candidate added to the bottom row, [DLQVGQVELGGGPGAGSLQPLALEGSLQKRGIVEQCCTSICSLYQLENYCN], includes [RGIVEQCCTSICSLYQLENYCN] at its right end, which is the partial amino acid sequence candidate that has the highest degree of overlap in list (C). Among the partial amino acid sequence candidates corresponding to the fragments obtained as a result of the cleavage by Asp-N, the sequence expressed as [DLQVGQVELGGGPGAGSLQPLALEGSLQKRGIVEQCCTSISCLYQLENYCN] is similar to the aforementioned one but does not match any of the sequences shown in list (C) in FIG. 7. Since the partial amino acid sequence candidate shown in the topmost row of list (D) can be combined with the one shown in the bottom row of the same list. Thus, the three kinds of partial amino acid sequence candidates shown in list (E) in FIG. 7 eventually remain as the candidates of the partial amino acid sequence including the terminal of the amino acid sequence of the sample. Among those candidates, the sequence expressed as [DLQVGQVELGGGPGAGSLQPLALEGSLQKRGIVEQCCTSICSLYQLENYCN], which has a degree of overlap of four, is most likely to be the correct solution.

The terminal sequence candidate identifier 25 also extracts partial amino acid sequence candidates which are likely to include the N-terminal of the amino acid sequence of the sample, in a manner similar to the previous case of extracting partial amino acid sequence candidates which include the C-terminal.

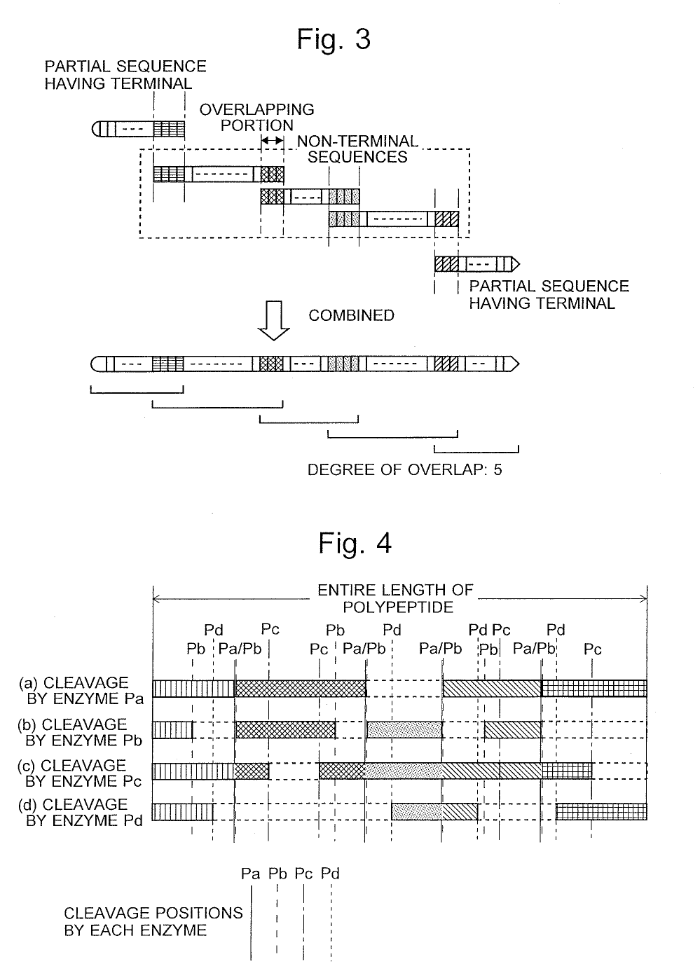

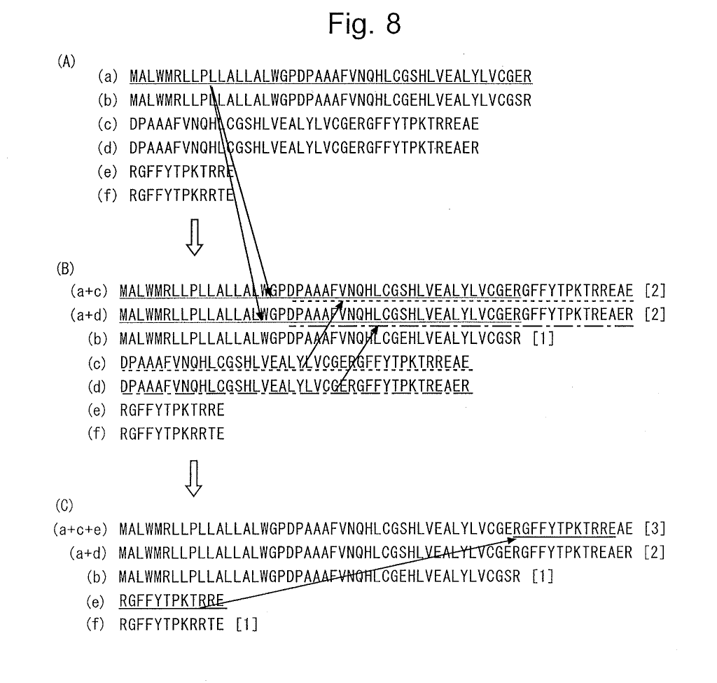

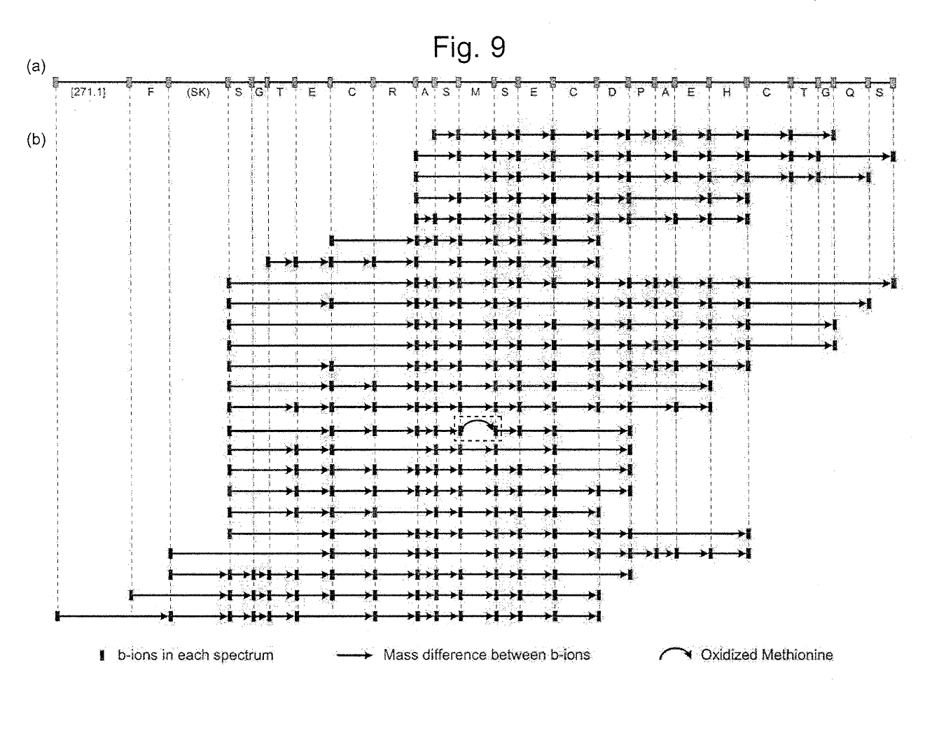

Next, the sequence combining processor 26 deduces the other amino acid sequences which include neither the N-terminal nor C-terminal of the amino acid sequence of the sample, by repeating the task of searching for an overlapping portion in two partial amino acid sequence candidates and combining them with their overlapping portions superposed on each other (Step S7). FIG. 3 is a conceptual diagram of the method for combining partial amino acid sequence candidates. FIG. 4 is an explanatory diagram specifically showing a method for reconstructing the amino acid sequence of a polypeptide sample while repeating the checking by combining partial amino acid sequence candidates. FIG. 8 shows one example of such a sequence reconstruction process. Sequences (a)-(f) in list (A) in FIG. 8 are six partial amino acid sequence candidates which are shown in FIG. 6 and which do not include the terminal. Specifically, (a) and (b) are candidates deduced for peptide fragments prepared using trypsin, (c) and (d) are candidates deduced for peptide fragments prepared using Asp-N, and (e) and (f) are candidates deduced for peptide fragments prepared using V8.

The process of combining amino acid sequence candidates is as follows: For a given partial amino acid sequence candidate corresponding to a certain kind of digestive enzyme, the partial amino acid sequence candidates corresponding to the other kinds of digestive enzymes, exclusive of the sequence candidates which have been judged to be the partial amino acid sequences including the C-terminal or N-terminal, are searched for a partial amino acid sequence candidate whose sequence partially matches that of the given candidate, i.e. which has an overlapping portion. When an overlapping portion is found, the two partial amino acid sequence candidates are combined, using the overlapping portion as the “tab for sticking”, to make a new partial amino acid sequence candidate having a longer sequence (see FIG. 3).

In FIG. 3, for ease of understanding, it is assumed that no overlap is present in the partial sequence between one “tab for sticking” and the other. In practice, by increasing the number of kinds of digestive enzymes used, it is possible to make an overlap not only at the “tab for sticking” but also over a longer sequence, possibly over the entire length. FIG. 4 shows one example of the case where the overlap is made over the entire length in the case of using four kinds of digestive enzymes Pa, Pb, Pc and Pd.

In FIG. 4, the vertical lines, i.e. the solid lines, roughly broken lines, chain lines and finely broken lines, represent the positions at which the sequence is cleaved by enzymes Pa, Pb, Pc and Pd, respectively. As shown in this figure, different kinds of digestive enzymes cause cleavage at different positions in the amino acid sequence of the sample. In the present example, enzymes Pa and Pb have some cleavage positions overlapping each other. This corresponds to, for example, the relationship between trypsin (which causes cleavage on the right side of K or R) and Arg-C (which causes cleavage only on the right side of R) or Lys-C (which causes cleavage only on the right side of K). As shown in (a) in FIG. 4, enzyme Pa divides the entire amino acid sequence of the polypeptide sample into five fragments, among which the central fragment indicated by the broken line means that this fragment is insufficiently ionized and cannot be measured. The portions identified by their respective filling patterns indicate that only the consistent portions of the sequences can be aligned.

Thus, even if there are a number of fragments that cannot be sufficiently detected for the digestive-fragment mixture obtained by each enzyme, it is possible to have two or more overlapping fragments at any position over the entire length of the original polypeptide by appropriately increasing the number of kinds of enzymes. In this situation, only the fragments which are the “correct solutions” can be selected over the entire length of the polypeptide since there are a plurality of sequence candidates superposed at any position in the polypeptide sequence. That is to say, the correct solutions can be exclusively sorted out by using the overlap not only at the portions serving as the “tab for sticking” as shown in FIG. 3 but also at the other portions. The number of enzymes to be used for this purpose is not limited to four but can be appropriately chosen taking into account the length of the original polypeptide, the kinds of enzymes and other factors so that at least two fragments overlapping each other will be obtained at any position over the entire length of the original polypeptide. Preferably, at least two kinds of enzymes should be used, and more preferably, three or more.

One specific example is hereinafter described with reference to FIG. 8. Initially, with each of the partial amino acid sequence candidates (a) and (b) in list (A) selected as the target, the partial amino acid sequence candidates (c) and (d) which correspond to a different digestive enzyme are searched for a partial sequence which matches a portion of the target sequence. In the present case, the sequence [DPAAAFVNQHLCGSHLVEALYLVCGER] is found to be matching. Using this matching portion as the “tab for sticking”, the partial amino acid sequence candidate (a) can be combined with the partial amino acid sequence candidate (c). Similarly, the partial amino acid sequence candidate (a) can also be combined with still another partial amino acid sequence candidate (d). By contrast, the partial amino acid sequence candidate (b) has no “tab for sticking” and cannot be combined with any of the partial amino acid sequence candidates (c) and (d). Thus, as shown in list (B) in FIG. 8, two new candidates are created: the partial amino acid sequence candidates (a+c) obtained by combining the two partial amino acid sequence candidates (a) and (c); and the partial amino acid sequence candidate (a+d) obtained by combining the two partial amino acid sequence candidates (a) and (d). Both of the two partial amino acid sequence candidates (a+c) and (a+d) have a degree of overlap of two, since each of them has been obtained by combining two partial amino acid sequence candidates.

Subsequently, for each of the partial amino acid sequence candidates having the sequences thus extended, the remaining partial amino acid sequence candidates are similarly searched for an overlapping portion in the previously described manner (Step S8). If an overlapping portion is found, the operation returns to Step S7 to once more perform the combining process. By repeating these tasks, the sequences are gradually extended.

In the case of list (B) in FIG. 8, each of the two partial amino acid sequence candidates (a+c) and (a+d) obtained by the aforementioned combination is examined as to whether it can be combined with any of the other partial amino acid sequence candidates (e) and (f). As a result, it is found that the partial amino acid sequence candidate (a+c) can entirely include the partial amino acid sequence candidate (e). Accordingly, as shown in list (C) in FIG. 8, the partial amino acid sequence candidate (a+c+e) created by combining the partial amino acid sequence candidate (e) with (a+c) (although there is actually no change in the sequence) has a degree of overlap of three. Meanwhile, the other partial amino acid sequence candidates remain intact.

By repeating the task of searching for an overlapping portion among the partial amino acid sequence candidates and combining the matched candidates, partial amino acid sequence candidates with high degrees of overlap are sorted out. A candidate having a higher degree of overlap is supposed to be a more correctly deduced result. This supposition is reasonable because one can assume, with a high degree of certainty, that it is most unlikely that a number of partial amino acid sequence candidates incorrectly deduced by de novo sequencing occur randomly and consistently over the entire length of a protein. In the case of combining only two partial amino acid sequence candidates, even when one or both of them are incorrectly deduced sequences, it is still possible that they can be accidentally combined. However, the probability of an incorrectly deduced sequence being consistently combined with other sequences exponentially decreases as the number of sequences is increased to three, four and so on. For example, in the case of combining several sequences, it is expected that the probability of an incorrectly deduced sequence being mixed in the final selection will be practically zero.

When it is no longer possible to find any partial amino acid sequence candidate that can be combined (“No” in Step S8), the sequence combining processor 26 connects the partial amino acid sequence candidate including the C-terminal and the partial amino acid sequence candidate including the N-terminal, which have been previously extracted by the terminal sequence candidate identifier 25, to the two ends of the partial amino acid sequence candidates obtained by the repetitive combining process, using the overlapping portion as the tab for sticking, to complete an amino acid sequence that is consistent with the sequences of the two terminals determined based on the information on the cleavage sites of the digestive enzymes (Step S9).

With one or more amino acid sequences thus eventually deduced, the sequence result checker 27 sorts out one or more amino acid sequences, or ranks them, based on the degree of overlap which indicates the number of partial amino acid sequence candidates used in the combining process (Step S10). For example, when a plurality of amino acid sequences have been obtained, only the sequence having the highest degree of overlap is judged to be the “correctly deduced result” and selected.

The judgment may also be made by determining the amino acid composition of each of the obtained amino acid sequences and comparing it with amino acid composition information of the sample, to select, as the correct solution, an amino acid sequence having the same amino acid composition as the sample. If the amino acid sequence being analyzed includes a repetition of the same partial sequence, the length of the “tab for sticking” may be incorrectly determined in Step S7, since neither the presence of such a repetition nor the number of times of the repetition is previously known. Even in such a case, incorrectly deduced results can be excluded by the aforementioned test of whether or not the result is consistent with the known amino acid composition information. Accordingly, the most appropriate result can be eventually sorted out by elimination.

The display processor 28 shows the eventually obtained amino acid sequence as the amino acid sequence of the sample on the screen of the display unit 4, thus presenting it to an analysis operator (Step S11). If it is impossible to select a single amino acid sequence, the eventually selected sequences can be displayed together with the ranking given in Step S10.

As described to this point, the amino acid sequence analyzing system of the present embodiment does not merely display a number of amino acid sequences including the correct solution; it can show an analysis operator a single amino acid sequence that is the correct solution or a small number of candidates which have been ranked with high reliability.

It should be noted that the previously described embodiment is a mere example of the present invention, and any change, modification, addition or the like appropriately within the spirit of the present invention will naturally fall within the scope of claims of the present patent application.

### REFERENCE SIGNS LIST

1 . . . Mass Analyzer
2 . . . Analysis Processor Unit
21 . . . Spectrum Data Memory
22 . . . Spectrum Processor
23 . . . De Novo Sequence Deducer
24 . . . Partial Sequence Candidate Collector
25 . . . Terminal Sequence Candidate Identifier
26 . . . Sequence Combining Processor
27 . . . Sequence Result Checker
28 . . . Display Processor
3 . . . Input Unit
4 . . . Display Unit

1. An amino acid sequence analysis method for deducing an amino acid sequence of a target sample which is a polypeptide based on mass spectrum data collected by a mass spectrometry performed on a mixture of peptide fragments obtained by fragmenting the sample with an enzyme, the method comprising:
a) a partial sequence deduction step, in which, for mass spectrum data collected by performing a mass spectrometry on each of a plurality of kinds of peptide-fragment mixtures prepared by performing a fragmentation using a single kind of enzyme on the target sample for each of a plurality of kinds of enzymes, a partial amino acid sequence candidate corresponding to each fragment is determined by a sequence deduction using de novo sequencing;
b) a data collection step, in which information about the kind of enzyme used for the fragmentation and the partial amino acid sequence candidates determined in the partial sequence deduction step are collected;
c) a terminal sequence extraction step, in which a partial amino acid sequence including an N-terminal or C-terminal of the original polypeptide is extracted based on the partial amino acid sequence candidates and the enzyme information, using a fact that a cleavage occurs at a previously known specific site corresponding to the kind of enzyme;
d) a combining process execution step, in which an amino acid sequence candidate is derived by extending an amino acid sequence through a repetition of a task of selecting and combining only such partial amino acid sequence candidates that can be consistently overlapped at common partial sequences included in the partial amino acid sequence candidates, exclusive of the partial amino acid sequence candidates including the N-terminal or C-terminal, and by eventually combining the partial amino acid sequence including the terminal extracted in the terminal sequence extraction step;
e) a result check step, in which the number of partial amino acid sequence candidates used in the combining process is calculated for every amino acid sequence candidate created in the combining process execution step, and in which one or more amino acid sequence candidates are selected or ranked based on the calculated numbers; and
f) a result presentation step, in which the one or more amino acid sequence candidates selected or ranked in the result check step are presented as a deduction result of the amino acid sequence of the target sample.

2. The amino acid sequence analysis method according to claim 1, wherein:
the amino acid sequence candidates are narrowed down in the result check step, based on amino acid compositions derived from the amino acid sequence candidates created in the combining process execution step and based on known amino acid composition information of the target sample.

3. An amino acid sequence analysis system for deducing an amino acid sequence of a target sample which is a polypeptide based on mass spectrum data collected by performing a mass spectrometry on each of a plurality of kinds of peptide-fragment mixtures prepared by performing a fragmentation using a single kind of enzyme on the sample for each of a plurality of kinds of enzymes, the system comprising:
a) a partial sequence deducer for deducing, for mass spectrum data obtained for each of the plurality of kinds of peptide-fragment mixtures, a partial amino acid sequence candidate corresponding to each fragment by a sequence deduction using de novo sequencing;
b) a data collector for collecting information about the kind of enzyme used for the fragmentation and the partial amino acid sequence candidates determined by the partial sequence deducer;
c) a terminal sequence extractor for extracting a partial amino acid sequence including an N-terminal or C-terminal of the original polypeptide based on the partial amino acid sequence candidates and the enzyme information, using a fact that a cleavage occurs at a previously known specific site corresponding to the kind of enzyme;
d) a combining process executer for deriving an amino acid sequence candidate by extending an amino acid sequence through a repetition of a task of selecting and combining only such partial amino acid sequence candidates that can be consistently overlapped at common partial sequences included in the partial amino acid sequence candidates, exclusive of the partial amino acid sequence candidates including the N-terminal or C-terminal, and by eventually combining the partial amino acid sequence including the terminal extracted by the terminal sequence extractor;
e) a result checker for calculating the number of partial amino acid sequence candidates used in the combining process for every amino acid sequence candidate created by the combining process executor, and for selecting or ranking one or more amino acid sequence candidates based on the calculated numbers; and
f) a result presenter for presenting the one or more amino acid sequence candidates selected or ranked by the result checker as a deduction result of the amino acid sequence of the target sample.

4. The amino acid sequence analysis system according to claim 3, wherein:
the result checker narrows down the amino acid sequence candidates based on amino acid compositions derived from the amino acid sequence candidates created by the combining processor and based on known amino acid composition information of the target sample.
